(19) United States
(12) Patent Application Publication
(10) Pub. No.: US 2024/0296395 A1
(43) Pub. Date: Sep. 5, 2024

(54) NEAR-OPTIMAL SCHEDULING SYSTEM FOR CONSIDERING PROCESSING-TIME VARIATIONS AND REAL-TIME DATA STREAMING AND METHOD THEREOF

(71) Applicant: NATIONAL CHENG KUNG UNIVERSITY, Tainan City (TW)

(72) Inventors: Tsung-Han TSAI, Tainan City (TW); Bing YAN, Pittsford, NY (US); Peter B. LUH, Taipei City (TW); Haw-Ching YANG, Tainan City (TW); Mikhail A. BRAGIN, Rocky Hill, CT (US); Fan-Tien CHENG, Tainan City (TW)

(21) Appl. No.: 18/327,163

(22) Filed: Jun. 1, 2023

(30) Foreign Application Priority Data
Mar. 2, 2023 (TW) 112107476

(51) Int. Cl. G06Q 10/0631; G06N 3/0442; G06Q 10/04; G06Q 50/04

(52) U.S. Cl. CPC G06Q 10/0631; G06N 3/0442; G06Q 10/04; G06Q 50/04

(57) ABSTRACT

A near-optimal scheduling system for considering processing-time variations and real-time data streaming includes a data parser module, a publish subscribe mechanism module, a processing time prediction module and a scheduling optimization module. In the processing time prediction module, an orthogonal greedy algorithm and a recurrent neural network are used to extract key features and then predict varying operation processing time. By formulating the scheduling problem in an integer programming form, an ordinal-optimization (OO) embedded decomposition and coordination method is established in the scheduling optimization module to provide dynamic and near-optimal schedules in a computationally efficient manner. Moreover, a publish subscribe mechanism is developed in the publish subscribe mechanism module by using subscribe and publish methods to realize real-time needs. Through this mechanism, the messages (updated production states) are published as specific topics and subscribed by the required modules of a manufacturing execution system without hierarchy delays.

### RELATED APPLICATIONS

This application claims priority to Taiwan Application Serial Number 112107476, filed Mar. 2, 2023, which is herein incorporated by reference.

### BACKGROUND

### Technical Field

The present disclosure relates to a near-optimal scheduling system and a method thereof. More particularly, the present disclosure relates to a near-optimal scheduling system for considering processing-time variations and real-time data streaming and a method thereof.

### Description of Related Art

With low-volume lots and high-variety operations in semiconductor fabrication, the demand for production scheduling optimization becomes higher. However, when conventional production scheduling optimization uses linear programming to solve mixed production conditions of multiple products and multiple production tools in a factory, the scheduling performance often fails to meet expectations due to factors such as the inability to grasp the on-site conditions, the actual production situation on the production line and the time-consuming calculation of scheduling optimization. These problems will lead to limitations in production scheduling optimization for use in future semiconductor fabrication. Therefore, a near-optimal scheduling system for considering processing-time variations and real-time data streaming and a method thereof which are capable of real-time dynamic scheduling, considering the actual production situation on the production line and avoiding hierarchy delays are commercially desirable.

### SUMMARY

An object of the present disclosure is to provide a near-optimal scheduling system for considering processing-time variations and real-time data streaming and a method thereof. The present disclosure motivated by the need for effective dynamic scheduling presents an integrated framework including data parser, processing time prediction, scheduling optimization and simulation. Driven by events, the key processing time features can be extracted and various processing time can be predicted. Moreover, the present disclosure establishes an innovative Ordinal Optimization (OO) concepts decomposition and coordination method to provide a near-optimal dynamic schedule in a computationally efficient manner based on the predicted operation processing time. In addition, the publish subscribe mechanism can be published as specific topics and subscribed by the required modules of a manufacturing execution system (MES) without hierarchy delays. The impacts of rush orders are evaluated under the constraints of CPU time (i.e., time of subproblem solving) and the mixed integer programming gap (MIP Gap) of practical needs in the factory.

According to one aspect of the present disclosure, a near-optimal scheduling system for considering processing-time variations and real-time data streaming includes a data parser module, a publish subscribe mechanism module, a processing time prediction module and a scheduling optimization module. The data parser module is configured to parse a plurality of sets of historical work-in-process (WIP) data generated by a manufacturing execution system (MES) in past multiple production periods according to a statistical method, thereby obtaining a plurality of historical features of operation processing time in the multiple production periods. The publish subscribe mechanism module is signally connected to the data parser module and receives the historical features of operation processing time. The publish subscribe mechanism module transmits the historical features of operation processing time via a publish subscribe mechanism. The processing time prediction module is signally connected to the publish subscribe mechanism module and receives the historical features of operation processing time. The processing time prediction module analyzes the historical features of operation processing time according to an orthogonal greedy algorithm (OGA) and a recurrent neural network (RNN), thereby obtaining a predicted operation processing time in a next production period. The processing time prediction module transmits the predicted operation processing time to the publish subscribe mechanism module. The scheduling optimization module is signally connected to the publish subscribe mechanism module and receives the predicted operation processing time. The scheduling optimization module executes an ordinal-optimization algorithm on the predicted operation processing time to generate an optimized schedule report so that the optimized schedule report considers variation of the predicted operation processing time.

Therefore, the near-optimal scheduling system for considering processing-time variations and real-time data streaming of the present disclosure provides an optimized production schedule based on the predicted operation processing time and the publish subscribe mechanism to overcome the problems of the uncertain processing time and lack of considering on-site conditions in the conventional scheduling technique. Moreover, the mixed integer programming combined with the ordinal-optimization (OO) embedded decomposition and coordination method can effectively improve the efficiency of optimizing scheduling for multiple products on multiple production tools, and enable the optimized schedule to be conformed with the behavior of actual production. In addition, the use of the publish subscribe mechanism can effectively solve the delay of states of the production tools and on-site production conditions, thereby effectively improving the transmission efficiency of the production tools and production-related information.

In some embodiments, the data parser module is activated by a first trigger signal for every first time period. The processing time prediction module is activated by a second trigger signal for every second time period, and the scheduling optimization module is activated by a third trigger signal. A length of the first time period is different from a length of the second time period, and the first trigger signal, the second trigger signal, and the third trigger signal are different from each other.

In some embodiments, the statistical method includes at least one of an average value method, a standard deviation method, and a quartile method. The orthogonal greedy algorithm is a triple-phase orthogonal greedy algorithm (TPOGA), and the recurrent neural network is a long short-term memory (LSTM).

In some embodiments, the ordinal-optimization algorithm includes performing an initializing step. The initializing step includes initializing the predicted operation processing time to a predetermined value and performing linear programming (LP) for a sorting problem of the predicted operation processing time to decompose the sorting problem into a plurality of linear programming subproblems. The predetermined value includes a non-integer.

In some embodiments, the ordinal-optimization algorithm further includes performing a solving step. The solving step includes sequentially calling each of the linear programming subproblems, and solving each of the linear programming subproblems by a linear programming solver to obtain a non-integer variable.

In some embodiments, the ordinal-optimization algorithm further includes performing a rounding step and a checking step. The rounding step includes rounding the non-integer variable to generate a rounded integer variable. The checking step includes checking feasibility of the rounded integer variable to generate a feasibility check result and then determining to perform one of a subproblem cost computing step and a processing step according to the feasibility check result.

In some embodiments, in response to determining that the feasibility check result of the checking step is feasible, the subproblem cost computing step is performed, and the subproblem cost computing step includes computing cost of each of the linear programming subproblems to generate a subproblem cost value. In response to determining that the feasibility check result of the checking step is non-feasible, the processing step is performed. The processing step includes performing a ceiling operation and a flooring operation on the non-integer variable to generate a ceiling integer variable and a flooring integer variable.

In some embodiments, the ordinal-optimization algorithm further includes performing a judging step. The judging step is performed after the subproblem cost computing step and includes judging whether the subproblem cost value obtained in a current time satisfies a surrogate optimality condition to generate a conditional judgment result. The surrogate optimality condition includes that the subproblem cost value obtained in the current time is smaller than the subproblem cost value obtained in a previous time. In response to determining that the conditional judgment result is yes, a multiplier updating step is performed, and then the solving step is repeatedly performed. The multiplier updating step includes updating a Lagrangian multiplier. In response to determining that the conditional judgment result is no, the processing step is performed.

In some embodiments, the ordinal-optimization algorithm further includes performing a finding and computing step. The finding and computing step is performed after the processing step and includes finding a feasible solution by using the ceiling integer variable and the flooring integer variable and computing cost of one of the linear programming subproblems corresponding to the feasible solution to generate another subproblem cost value.

In some embodiments, the ordinal-optimization algorithm further includes performing a confirming step. The confirming step is performed after the finding and computing step and includes confirming whether the another subproblem cost value obtained in a current time satisfies another surrogate optimality condition to generate a conditional confirmation result. The another surrogate optimality condition includes that the another subproblem cost value obtained in the current time is smaller than the subproblem cost value obtained in a previous time. In response to determining that the conditional confirmation result is yes, the ordinal-optimization algorithm is stopped. In response to determining that the conditional confirmation result is no, a subproblem solving step is performed, and then a multiplier updating step is performed. The subproblem solving step includes solving each of the linear programming subproblems by using a branch and cut algorithm, and the multiplier updating step includes updating a Lagrangian multiplier.

According to another aspect of the present disclosure, a near-optimal scheduling system for considering processing-time variations and real-time data streaming includes a memory and a processor. The memory is configured to store a plurality of sets of historical work-in-process (WIP) data generated by a manufacturing execution system (MES) in past multiple production periods and a plurality of instructions. The processor is signally connected to the memory. The processor executes the instructions to perform a data parser operation, a first publish subscribe mechanism operation, a processing time prediction operation, a second publish subscribe mechanism operation and a scheduling optimization operation. The data parser operation includes parsing the sets of historical work-in-process data according to a statistical method, thereby obtaining a plurality of historical features of operation processing time in the multiple production periods. The first publish subscribe mechanism operation includes transmitting the historical features of operation processing time via a publish subscribe mechanism. The processing time prediction operation includes analyzing the historical features of operation processing time according to an orthogonal greedy algorithm (OGA) and a recurrent neural network (RNN), thereby obtaining a predicted operation processing time in a next production period. The second publish subscribe mechanism operation includes transmitting the predicted operation processing time via the publish subscribe mechanism. The scheduling optimization operation includes executing an ordinal-optimization algorithm on the predicted operation processing time to generate an optimized schedule report so that the optimized schedule report considers variation of the predicted operation processing time.

Therefore, the near-optimal scheduling system for considering processing-time variations and real-time data streaming of the present disclosure provides an optimized production schedule based on the predicted operation processing time and the publish subscribe mechanism to overcome the problems of the uncertain processing time and lack of considering on-site conditions in the conventional scheduling technique. Moreover, the mixed integer programming combined with the ordinal-optimization (OO) embedded decomposition and coordination method can effectively improve the efficiency of optimizing scheduling for multiple products on multiple production tools, and enable the optimized schedule to be conformed with the behavior of actual production. In addition, the use of the publish subscribe mechanism can effectively solve the delay of states of the production tools and on-site production conditions, thereby effectively improving the transmission efficiency of the production tools and production-related information.

According to further another aspect of the present disclosure, a near-optimal scheduling method for considering processing-time variations and real-time data streaming includes performing a data parsing step, a first publish subscribe mechanism step, a processing time predicting step, a second publish subscribe mechanism step and a scheduling optimization step. The data parsing step includes configuring a data parser module to parse a plurality of sets of historical work-in-process (WIP) data generated by a manufacturing execution system (MES) in past multiple production periods according to a statistical method, thereby obtaining a plurality of historical features of operation processing time in the multiple production periods. The first publish subscribe mechanism step includes configuring a publish subscribe mechanism module to transmit the historical features of operation processing time via a publish subscribe mechanism. The processing time predicting step includes configuring a processing time prediction module to analyze the historical features of operation processing time according to an orthogonal greedy algorithm (OGA) and a recurrent neural network (RNN), thereby obtaining a predicted operation processing time in a next production period. The second publish subscribe mechanism step includes configuring the publish subscribe mechanism module to transmit the predicted operation processing time via the publish subscribe mechanism. The scheduling optimization step includes configuring a scheduling optimization module to execute an ordinal-optimization algorithm on the predicted operation processing time to generate an optimized schedule report so that the optimized schedule report considers variation of the predicted operation processing time.

Therefore, the near-optimal scheduling method for considering processing-time variations and real-time data streaming of the present disclosure provides an optimized production schedule based on the predicted operation processing time and the publish subscribe mechanism to overcome the problems of the uncertain processing time and lack of considering on-site conditions in the conventional scheduling technique. Moreover, the mixed integer programming combined with the ordinal-optimization (OO) embedded decomposition and coordination method can effectively improve the efficiency of optimizing scheduling for multiple products on multiple production tools, and enable the optimized schedule to be conformed with the behavior of actual production. In addition, the use of the publish subscribe mechanism can effectively solve the delay of states of the production tools and on-site production conditions, thereby effectively improving the transmission efficiency of the production tools and production-related information.

In some embodiments, the data parser module is activated by a first trigger signal for every first time period. The processing time prediction module is activated by a second trigger signal for every second time period, and the scheduling optimization module is activated by a third trigger signal. A length of the first time period is different from a length of the second time period, and the first trigger signal, the second trigger signal, and the third trigger signal are different from each other. In addition, the statistical method includes at least one of an average value method, a standard deviation method, and a quartile method. The orthogonal greedy algorithm is a triple-phase orthogonal greedy algorithm (TPOGA), and the recurrent neural network is a long short-term memory (LSTM).

In some embodiments, the ordinal-optimization algorithm includes performing an initializing step. The initializing step includes initializing the predicted operation processing time to a predetermined value and performing linear programming (LP) for a sorting problem of the predicted operation processing time to decompose the sorting problem into a plurality of linear programming subproblems. The predetermined value includes a non-integer.

In some embodiments, the ordinal-optimization algorithm further includes performing a solving step. The solving step includes sequentially calling each of the linear programming subproblems, and solving each of the linear programming subproblems by a linear programming solver to obtain a non-integer variable.

In some embodiments, the ordinal-optimization algorithm further includes performing a rounding step and a checking step. The rounding step includes rounding the non-integer variable to generate a rounded integer variable. The checking step includes checking feasibility of the rounded integer variable to generate a feasibility check result and then determining to perform one of a subproblem cost computing step and a processing step according to the feasibility check result.

In some embodiments, in response to determining that the feasibility check result of the checking step is feasible, the subproblem cost computing step is performed, and the subproblem cost computing step includes computing cost of each of the linear programming subproblems to generate a subproblem cost value. In response to determining that the feasibility check result of the checking step is non-feasible, the processing step is performed. The processing step includes performing a ceiling operation and a flooring operation on the non-integer variable to generate a ceiling integer variable and a flooring integer variable.

In some embodiments, the ordinal-optimization algorithm further includes performing a judging step. The judging step is performed after the subproblem cost computing step and includes judging whether the subproblem cost value obtained in a current time satisfies a surrogate optimality condition to generate a conditional judgment result. The surrogate optimality condition includes that the subproblem cost value obtained in the current time is smaller than the subproblem cost value obtained in a previous time. In response to determining that the conditional judgment result is yes, a multiplier updating step is performed, and then the solving step is repeatedly performed. The multiplier updating step includes updating a Lagrangian multiplier. In response to determining that the conditional judgment result is no, the processing step is performed.

In some embodiments, the ordinal-optimization algorithm further includes performing a finding and computing step. The finding and computing step is performed after the processing step and includes finding a feasible solution by using the ceiling integer variable and the flooring integer variable and computing cost of one of the linear programming subproblems corresponding to the feasible solution to generate another subproblem cost value.

In some embodiments, the ordinal-optimization algorithm further includes performing a confirming step. The confirming step is performed after the finding and computing step and includes confirming whether the another subproblem cost value obtained in a current time satisfies another surrogate optimality condition to generate a conditional confirmation result. The another surrogate optimality condition includes that the another subproblem cost value obtained in the current time is smaller than the subproblem cost value obtained in a previous time. In response to determining that the conditional confirmation result is yes, the ordinal-optimization algorithm is stopped. In response to determining that the conditional confirmation result is no, a subproblem solving step is performed, and then a multiplier updating step is performed. The subproblem solving step includes solving each of the linear programming subproblems by using a branch and cut algorithm, and the multiplier updating step includes updating a Lagrangian multiplier.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a near-optimal scheduling system for considering processing-time variations and real-time data streaming according to a first embodiment of the present disclosure.

FIG. 2 shows a flow chart of an ordinal-optimization algorithm of a scheduling optimization module of the near-optimal scheduling system of FIG. 1.

FIG. 3 shows a flow chart of a near-optimal scheduling method for considering processing-time variations and real-time data streaming according to a second embodiment of the present disclosure.

FIG. 4 shows a schematic view of a near-optimal scheduling system for considering processing-time variations and real-time data streaming according to a third embodiment of the present disclosure.

FIG. 5 shows a schematic view of a near-optimal scheduling system for considering processing-time variations and real-time data streaming according to a fourth embodiment of the present disclosure.

FIG. 6 shows a schematic view of a writing delay of states of a production tool utilizing a publish subscribe mechanism of the present disclosure when a writing frequency is 100 Hz.

FIG. 7 shows a schematic view of a writing delay of states of a production tool utilizing a publish subscribe mechanism of the present disclosure when a writing frequency is 10 Hz.

### DETAILED DESCRIPTION

The embodiment will be described with the drawings. For clarity, some practical details will be described below. However, it should be noted that the present disclosure should not be limited by the practical details, that is, in some embodiment, the practical details are unnecessary. In addition, for simplifying the drawings, some conventional structures and elements will be simply illustrated, and repeated elements may be represented by the same labels.

It will be understood that when an element (or device, module) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

With low-volume lots and high-variety operations, it is challenging for the schedule to effectively meet the manufacturing needs. In addition to the combinatorial operation nature of the problem, it is also difficult to efficiently deal with uncertain processing time, on-site conditions and production conditions are constantly changing in a conventional manufacturing execution system hierarchy. Therefore, a novel framework is presented to address the above challenges. In the proposed framework, an orthogonal greedy algorithm (OGA) and a recurrent neural network (RNN) are used to extract key features and then predict varying operation processing time. By formulating the scheduling problem in an integer programming form, an ordinal-optimization (OO) embedded decomposition and coordination method is established to provide dynamic and near-optimal schedules in a computationally efficient manner. Moreover, a mechanism of publish and subscribe is developed by using publish and subscribe methods to realize real-time needs. Through this mechanism, the messages (updated production states) will be published as specific topics and subscribed by the required modules of a manufacturing execution system (MES) without hierarchy delays.

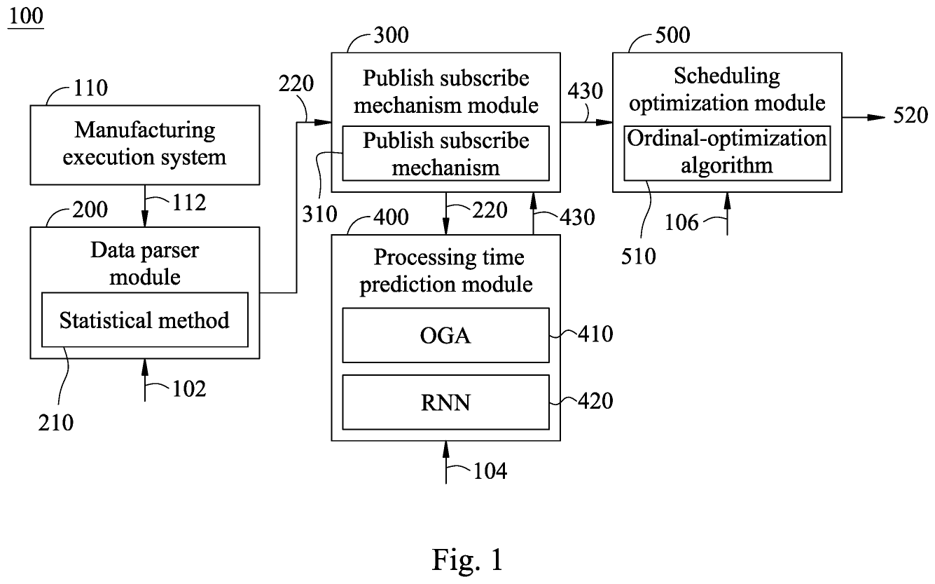

Reference is made to FIG. 1. FIG. 1 shows a schematic view of a near-optimal scheduling system 100 for considering processing-time variations and real-time data streaming according to a first embodiment of the present disclosure. The near-optimal scheduling system 100 for considering processing-time variations and real-time data streaming includes a data parser module 200, a publish subscribe mechanism module 300, a processing time prediction module 400 and a scheduling optimization module 500.

The data parser module 200 is configured to parse a plurality of sets of historical work-in-process (WIP) data 112 generated by a manufacturing execution system (MES) 110 in past multiple production periods according to a statistical method 210, thereby obtaining a plurality of historical features of operation processing time 220 in the multiple production periods. In one embodiment, the statistical method 210 includes at least one of an average value method, a standard deviation method, and a quartile method, but the present disclosure is not limited thereto.

The publish subscribe mechanism module 300 is signally connected to the data parser module 200 and receives the historical features of operation processing time 220. The publish subscribe mechanism module 300 transmits the historical features of operation processing time 220 via a publish subscribe mechanism 310. The historical features can be published as specific topics via the publish subscribe mechanism 310 and subscribed by the required modules of the manufacturing execution system 110 without hierarchy delays.

The processing time prediction module 400 is signally connected to the publish subscribe mechanism module 300 and receives the historical features of operation processing time 220. The processing time prediction module 400 analyzes the historical features of operation processing time 220 according to an orthogonal greedy algorithm (OGA) 410 and a recurrent neural network (RNN) 420, thereby obtaining a predicted operation processing time 430 in a next production period. The processing time prediction module 400 transmits the predicted operation processing time 430 to the publish subscribe mechanism module 300. In one embodiment, the orthogonal greedy algorithm 410 is a triple-phase orthogonal greedy algorithm (TPOGA), and the recurrent neural network 420 is a long short-term memory (LSTM), but the present disclosure is not limited thereto.

The scheduling optimization module 500 is signally connected to the publish subscribe mechanism module 300 and receives the predicted operation processing time 430. The scheduling optimization module 500 executes an ordinal-optimization (OO) algorithm 510 on the predicted operation processing time 430 to generate an optimized schedule report 520 so that the optimized schedule report 520 considers variation of the predicted operation processing time 430.

The data parser module 200 may be activated by a first trigger signal 102 for every first time period. The processing time prediction module 400 may be activated by a second trigger signal 104 for every second time period. The scheduling optimization module 500 may be activated by a third trigger signal 106. The length of the first time period is different from the length of the second time period, and the first trigger signal 102, the second trigger signal 104, and the third trigger signal 106 are different from each other. In one embodiment, the length of the first time period may be one day, and the length of the second time period may be one week (i.e., seven days), but the present disclosure is not limited thereto. Therefore, the near-optimal scheduling system 100 for considering processing-time variations and real-time data streaming of the present disclosure provides an optimized production schedule based on the predicted operation processing time 430 and the publish subscribe mechanism 310 to overcome the problems of the uncertain processing time and lack of considering on-site conditions in the conventional scheduling technique. Moreover, the mixed integer programming combined with the ordinal-optimization (OO) embedded decomposition and coordination method (i.e., using the ordinal-optimization algorithm 510) can effectively improve the efficiency of optimizing scheduling for multiple products on multiple production tools, and enable the optimized schedule to be conformed with the behavior of actual production. In addition, the use of the publish subscribe mechanism 310 can effectively solve the delay of states of the production tools and on-site production conditions, thereby effectively improving the transmission efficiency of the production tools and production-related information.

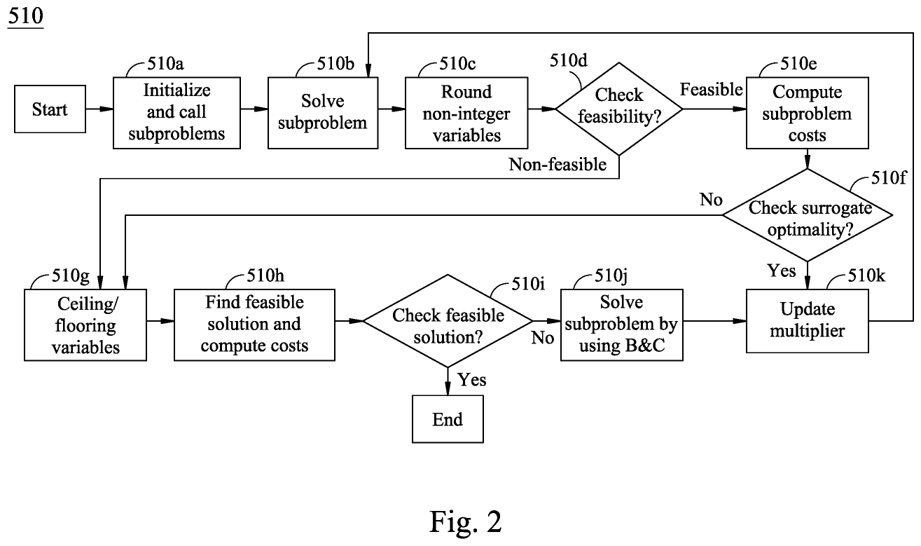

Reference is made to FIGS. 1 and 2. FIG. 2 shows a flow chart of an ordinal-optimization algorithm 510 of a scheduling optimization module 500 of the near-optimal scheduling system 100 of FIG. 1. The ordinal-optimization algorithm 510 includes performing an initializing step 510a, a solving step 510b, a rounding step 510c, a checking step 510d, a subproblem cost computing step 510e, a judging step 510f, a processing step 510g, a finding and computing step 510h, a confirming step 510i, a subproblem solving step 510j and a multiplier updating step 510k.

The initializing step 510a is “Initialize and call subproblems”, and includes initializing the predicted operation processing time 430 to a predetermined value and performing linear programming (LP) for a sorting problem of the predicted operation processing time 430 to decompose the sorting problem into a plurality of linear programming subproblems. The predetermined value includes a non-integer. In other words, the initializing step 510a can relax the sorting problem from an integer linear programming (ILP) to an LP subproblem.

The solving step 510b is “Solve subproblem”, and includes sequentially calling each of the linear programming subproblems, and solving each of the linear programming subproblems by a linear programming solver to obtain a non-integer variable.

The rounding step 510c is “Round non-integer variables”, and includes rounding the non-integer variable to generate a rounded integer variable.

The checking step 510d is “Check feasibility?”, and includes checking feasibility of the rounded integer variable to generate a feasibility check result and then determining to perform one of a subproblem cost computing step 510e and a processing step 510g according to the feasibility check result. In other words, the checking step 510d is performed to check the integer variable after being rounded (i.e., the rounded integer variable) of the rounding step 510c and compute the feasibility of a solution of the rounded integer variable. In response to determining that the feasibility check result of the checking step 510d is feasible, the subproblem cost computing step 510e is performed. In contrast, in response to determining that the feasibility check result of the checking step 510d is non-feasible, the processing step 510g is performed.

The subproblem cost computing step 510e is “Compute subproblem costs”, and includes computing cost of each of the linear programming subproblems to generate a subproblem cost value.

The judging step 510f is “Check surrogate optimality?” and performed after the subproblem cost computing step 510e. The judging step 510f includes judging whether the subproblem cost value obtained in a current time (k) satisfies a surrogate optimality condition to generate a conditional judgment result. The surrogate optimality condition includes that the subproblem cost value obtained in the current time (k) is smaller than the subproblem cost value obtained in the previous time (k−1). In response to determining that the conditional judgment result is yes, the multiplier updating step 510k is performed, and then the solving step 510b is repeatedly performed. In contrast, in response to determining that the conditional judgment result is no, the processing step 510g is performed.

The processing step 510g is “Ceiling/flooring variables”, and includes performing a ceiling operation and a flooring operation on the non-integer variable to generate a ceiling integer variable and a flooring integer variable.

The finding and computing step 510h is “Find feasible solution and compute costs” and performed after the processing step 510g. The finding and computing step 510h includes finding a feasible solution by using the ceiling integer variable and the flooring integer variable and computing cost of one of the linear programming subproblems corresponding to the feasible solution to generate another subproblem cost value.

The confirming step 510i is “Check feasible solution?” and performed after the finding and computing step 510h. The confirming step 510i includes confirming whether the another subproblem cost value obtained in a current time (k) satisfies another surrogate optimality condition to generate a conditional confirmation result. The another surrogate optimality condition includes that the another subproblem cost value obtained in the current time (k) is smaller than the subproblem cost value obtained in the previous time (k−1). In response to determining that the conditional confirmation result is yes, the ordinal-optimization algorithm 510 is stopped (i.e., stops the solving process). In contrast, in response to determining that the conditional confirmation result is no, the subproblem solving step 510j is performed, and then the multiplier updating step 510k is performed.

The subproblem solving step 510j is “Solve subproblem by using B&C”, and includes solving each of the linear programming subproblems by using a branch and cut (B&C) algorithm.

The multiplier updating step 510k is “Update multiplier”, and includes updating a Lagrangian multiplier. After performing the multiplier updating step 510k, the solving step 510b is repeatedly performed.

Therefore, the present disclosure utilizes the mixed integer programming combined with the ordinal-optimization (OO) embedded decomposition and coordination method (i.e., using the ordinal-optimization algorithm 510) to effectively improve the efficiency of optimizing scheduling for multiple products on multiple production tools, and enable the optimized schedule to be conformed with the behavior of actual production.

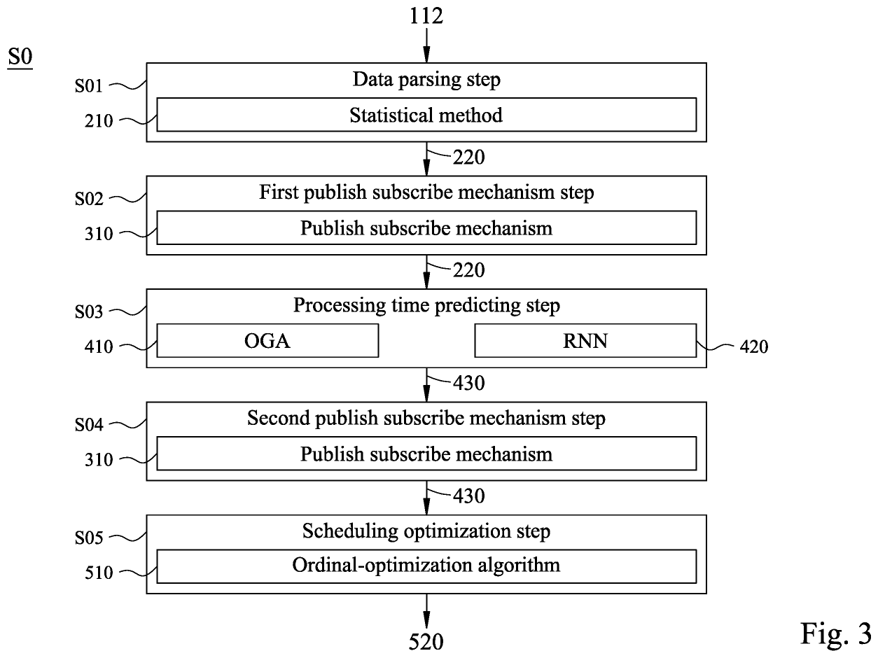

Reference is made to FIGS. 1, 2, and 3. FIG. 3 shows a flow chart of a near-optimal scheduling method SO for considering processing-time variations and real-time data streaming according to a second embodiment of the present disclosure. The near-optimal scheduling method SO for considering processing-time variations and real-time data streaming includes performing a data parsing step S01, a first publish subscribe mechanism step S02, a processing time predicting step S03, a second publish subscribe mechanism step S04 and a scheduling optimization step S05. The data parsing step S01, the first publish subscribe mechanism step S02, the processing time predicting step S03, the second publish subscribe mechanism step S04 and the scheduling optimization step S05 are performed sequentially.

The data parsing step S01 includes configuring a data parser module 200 to parse a plurality of sets of historical WIP data 112 generated by an MES 110 in past multiple production periods according to a statistical method 210, thereby obtaining a plurality of historical features of operation processing time 220 in the multiple production periods.

The first publish subscribe mechanism step S02 includes configuring a publish subscribe mechanism module 300 to transmit the historical features of operation processing time 220 via a publish subscribe mechanism 310. Specifically, the publish subscribe mechanism module 300 receives the historical features of operation processing time 220 and transmits the historical features of operation processing time 220 to a processing time prediction module 400 via the publish subscribe mechanism 310.

The processing time predicting step S03 includes configuring the processing time prediction module 400 to analyze the historical features of operation processing time 220 according to an OGA 410 and an RNN 420, thereby obtaining a predicted operation processing time 430 in the next production period.

The second publish subscribe mechanism step S04 includes configuring the publish subscribe mechanism module 300 to transmit the predicted operation processing time 430 via the publish subscribe mechanism 310. Specifically, the publish subscribe mechanism module 300 receives the predicted operation processing time 430 and transmits the predicted operation processing time 430 to a scheduling optimization module 500 via the publish subscribe mechanism 310.

The scheduling optimization step S05 includes configuring the scheduling optimization module 500 to execute an ordinal-optimization algorithm 510 on the predicted operation processing time 430 to generate an optimized schedule report 520 so that the optimized schedule report 520 considers the variation of the predicted operation processing time 430.

Therefore, the near-optimal scheduling method SO for considering processing-time variations and real-time data streaming of the present disclosure provides an optimized production schedule based on the predicted operation processing time 430 and the publish subscribe mechanism 310 to overcome the problems of the uncertain processing time and lack of considering on-site conditions in the conventional scheduling technique. Moreover, the mixed integer programming combined with the ordinal-optimization (OO) embedded decomposition and coordination method (i.e., using the ordinal-optimization algorithm 510) can effectively improve the efficiency of optimizing scheduling for multiple products on multiple production tools, and enable the optimized schedule to be conformed with the behavior of actual production. In addition, the use of the publish subscribe mechanism 310 can effectively solve the delay of states of the production tools and on-site production conditions, thereby effectively improving the transmission efficiency of the production tools and production-related information.

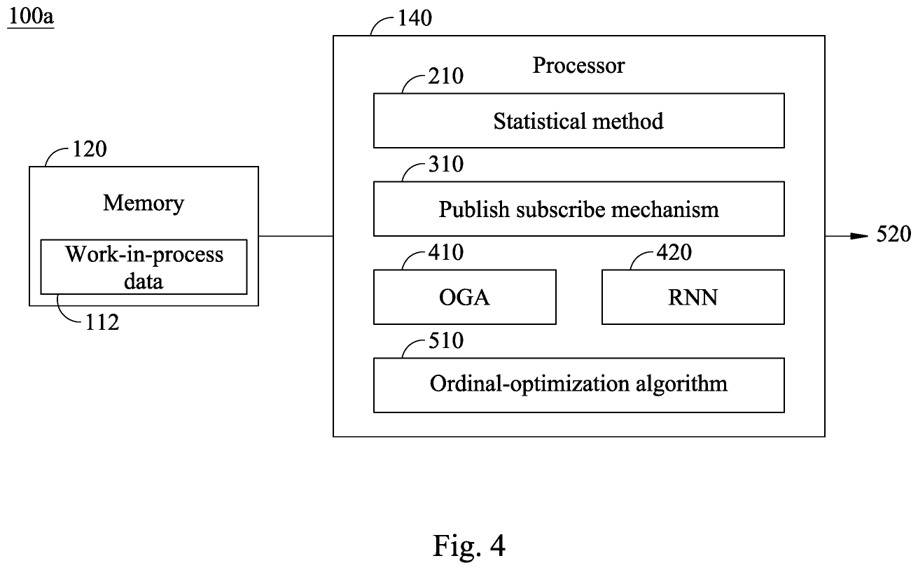

Reference is made to FIGS. 1, 2, 3, and 4. FIG. 4 shows a schematic view of a near-optimal scheduling system 100a for considering processing-time variations and real-time data streaming according to a third embodiment of the present disclosure. The near-optimal scheduling system 100a for considering processing-time variations and real-time data streaming includes a memory 120 and a processor 140.

The memory 120 is configured to store a plurality of sets of historical WIP data 112 generated by an MES 110 in past multiple production periods and a plurality of instructions. The processor 140 is signally connected to the memory 120. The processor 140 executes the instructions to perform a plurality of operations, and the operations include a data parser operation, a first publish subscribe mechanism operation, a processing time prediction operation, a second publish subscribe mechanism operation and a scheduling optimization operation.

The data parser operation includes parsing the sets of historical WIP data 112 according to a statistical method 210, thereby obtaining a plurality of historical features of operation processing time 220 in the multiple production periods. The data parser operation is corresponding to the data parsing step S01 of FIG. 3.

The first publish subscribe mechanism operation includes transmitting the historical features of operation processing time 220 via a publish subscribe mechanism 310. The first publish subscribe mechanism operation is corresponding to the first publish subscribe mechanism step S02 of FIG. 3.

The processing time prediction operation includes analyzing the historical features of operation processing time 220 according to an OGA 410 and an RNN 420, thereby obtaining a predicted operation processing time 430 in the next production period. The processing time prediction operation is corresponding to the processing time predicting step S03 of FIG. 3.

The second publish subscribe mechanism operation includes transmitting the predicted operation processing time 430 via the publish subscribe mechanism 310. The second publish subscribe mechanism operation is corresponding to the second publish subscribe mechanism step S04 of FIG. 3.

The scheduling optimization operation includes executing an ordinal-optimization algorithm 510 on the predicted operation processing time 430 to generate an optimized schedule report 520 so that the optimized schedule report 520 considers the variation of the predicted operation processing time 430. The scheduling optimization operation is corresponding to the scheduling optimization step S05 of FIG. 3.

The memory 120 may include a random access memory (RAM) or another type of dynamic storage device that may store information and instructions for execution by the processor 140. The processor 140 may include any type of processor, microprocessor, or processing logic that may interpret and execute instructions (e.g., a field programmable gate array (FPGA)). The processor 140 may include a single device (e.g., a single core) and/or a group of devices (e.g., multi-cores).

Therefore, the near-optimal scheduling system 100a for considering processing-time variations and real-time data streaming of the present disclosure provides an optimized production schedule based on the predicted operation processing time 430 and the publish subscribe mechanism 310 to overcome the problems of the uncertain processing time and lack of considering on-site conditions in the conventional scheduling technique. Moreover, the mixed integer programming combined with the ordinal-optimization (OO) embedded decomposition and coordination method (i.e., using the ordinal-optimization algorithm 510) can effectively improve the efficiency of optimizing scheduling for multiple products on multiple production tools, and enable the optimized schedule to be conformed with the behavior of actual production. In addition, the use of the publish subscribe mechanism 310 can effectively solve the delay of states of the production tools and on-site production conditions, thereby effectively improving the transmission efficiency of the production tools and production-related information.

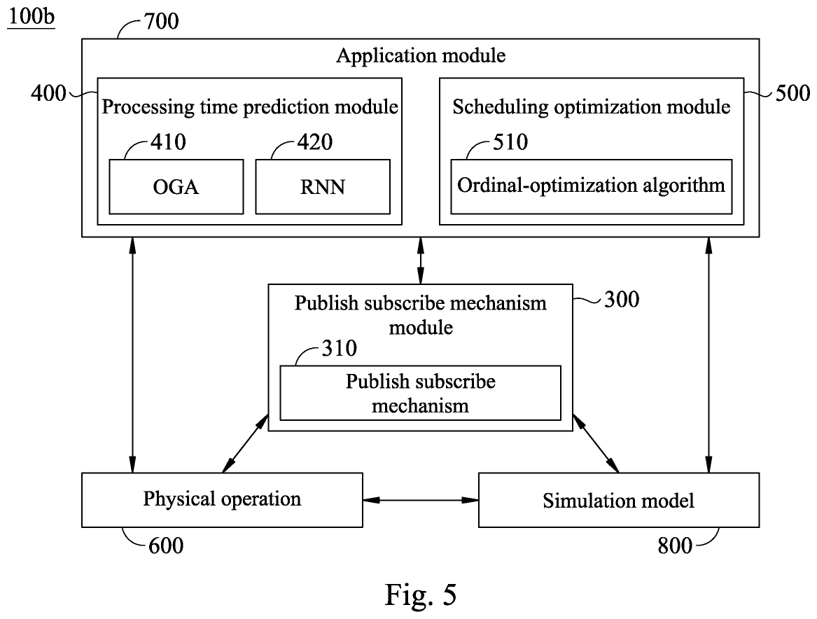

Reference is made to FIGS. 1, 3, and 5. FIG. 5 shows a schematic view of a near-optimal scheduling system 100b for considering processing-time variations and real-time data streaming according to a fourth embodiment of the present disclosure. The near-optimal scheduling system 100b for considering processing-time variations and real-time data streaming is utilized to establish an optimal schedule of a physical operation 600, and includes the physical operation 600, an application module 700, a publish subscribe mechanism module 300 and a simulation model 800.

The physical operation 600 is corresponding to the MES 110 and the data parser module 200 of FIG. 1. The application module 700 includes a processing time prediction module 400 and a scheduling optimization module 500. The publish subscribe mechanism module 300 is signally connected to the physical operation 600, the application module 700 and the simulation model 800. The physical operation 600, the application module 700 and the simulation model 800 are signally connected to each other. The publish subscribe mechanism module 300, the processing time prediction module 400 and the scheduling optimization module 500 are the same as the publish subscribe mechanism module 300, the processing time prediction module 400 and the scheduling optimization module 500 of FIG. 1, respectively. The simulation model 800 is a virtual model corresponding to the physical operation 600. The simulation model 800 executes the optimized schedule report 520 of the scheduling optimization module 500. Therefore, the near-optimal scheduling system 100b for considering processing-time variations and real-time data streaming of the present disclosure integrates the physical operation 600, the application module 700, the publish subscribe mechanism module 300 and the simulation model 800 to establish the optimal schedule of the physical operation 600. In one embodiment, the application module 700 can utilize the LSTM to predict the processing time, and perform production lot-scheduling by using the ordinal-optimization (OO) embedded decomposition and coordination method (i.e., using the ordinal-optimization algorithm 510). In addition, the present disclosure transmits information among the physical operation 600 (actual on-site production), the application module 700 and the simulation model 800 with a flat architecture via the publish subscribe mechanism 310, thereby avoiding hierarchy delay.

Reference is made to FIGS. 1-5 and Table 1. Table 1 lists a comparison of the on-time completion rates between a conventional expert experience (actual rate) and the near-optimal scheduling of the present disclosure. In detail, Table 1 compares the on-time completion rates of the actual and the near-optimal scheduling of the three flows (i.e., “Flow 1-3”) for 2 durations (i.e., “Days 1-62” and “Days 82-125”) based on the first version of the actual schedules from the historical data, in which the actual on-time completion rate is the number of on-time lots over the total lots. Compared to the actual results, the mean on-time completion rate of Flow 1 of the present disclosure under the constraints of the processor operation time (CPU Time) and the mixed integer programming gap (MIP Gap) can be improved by 0.65% (i.e., ((99.38%−98.85%)+(99.06%−98.28%))/2) even in the high actual completion rate (over 98%) after applying the near-optimal scheduling daily. All the on-time completion rates of the three flows by using the near-optimal scheduling of the present disclosure are better than the actual ones, and the solutions are obtained within the CPU time and the MIP gap requirements. In addition, although the actual rates of Flow 3 are low (i.e., 66.67% and 8.10%), the space for improvement by using the near-optimal scheduling of the present disclosure is still limited (i.e., 71.11% and 21.62%). The results demonstrate the scheduling optimization module 500 with the ordinal-optimization (OO) embedded decomposition and coordination method (i.e., using the ordinal-optimization (OO) algorithm 510) is computationally efficient in optimizing scheduling for dynamic needs. In other words, the present disclosure can effectively evaluate the impacts of rush orders under the constraints of the CPU time (i.e., time of subproblem solving) and the MIP Gap of practical needs in the factory.

TABLE 1

| | | Actual | Present Disclosure | | |
|---|---|---|---|---|---|
| | | On-time | On-time | | |
| | | Completion | Completion | | |
| | | Rate | Rate | MIP | CPU Time |
| Days | Flow | (%) | (%) | Gap | (mins) |
| 1-62 | 1 | 98.85 | 99.38 | 3.40 | 13-14.8 |
| | 2 | 92.40 | 97.15 | | |
| | 3 | 66.67 | 71.11 | | |
| 82-125 | 1 | 98.28 | 99.06 | 3.55 | 13.2-14.3 |
| | 2 | 60.49 | 70.63 | | |
| | 3 | 8.10 | 21.62 | | |

Reference is made to FIGS. 1-5 and Table 2. Table 2 lists a comparison of the CPU time among a conventional branch and cut (B&C), Surrogate Lagrangian Relaxation (SLR) and the ordinal-optimization (OO) embedded decomposition and coordination method (i.e., using the ordinal-optimization (OO) algorithm 510) of the present disclosure. In detail, when applying the B&C with a cold start, where the initial values of the decision variables are zero before solving, it takes 7438 seconds to achieve a solution with a MIP gap of less than 5%, as listed in Table 2. However, when applying the SLR and OO embedded decomposition and coordination method, the CPU time is reduced to 76.7% (i.e., 5700/7438) and 38.7% (i.e., 2880/7438) of the time required by the B&C, respectively, under the same stop-gap (MIP GAP) requirement. To reduce the time of subproblem solving, the pre-loaded initial solutions can serve as the initial variables for efficient subproblem solving. These initial solutions (referred to as the warm start) are usually composed of pairs of variables and values, or the feasible solutions to the problem including the decision variables and Lagrange multipliers. After using the warm start, the SLR and the OO embedded decomposition and coordination method can reduce the CPU time by 82.5% (i.e., 100%−997/5700%) and 79.2% (i.e., 100%−599/2880%) as compared to the cold start, respectively. The result indicates that the OO embedded decomposition and coordination method (OO embedded SLR) of the present disclosure takes less time (<10 mins) to find a solution that satisfies the stop-gap (MIP GAP) requirement.

TABLE 2

| | | CPU Time (s) | |
|---|---|---|---|
| Formulation | MIP Gap (%) | Cold Start | Warm Start |
| B&C | 4.99 | 7438 | N/A |
| SLR | 3.99 | 5700 | 997 |
| OO embedded | 3.97 | 2880 | 599 |
| decomposition and | | | |
| coordination method | | | |

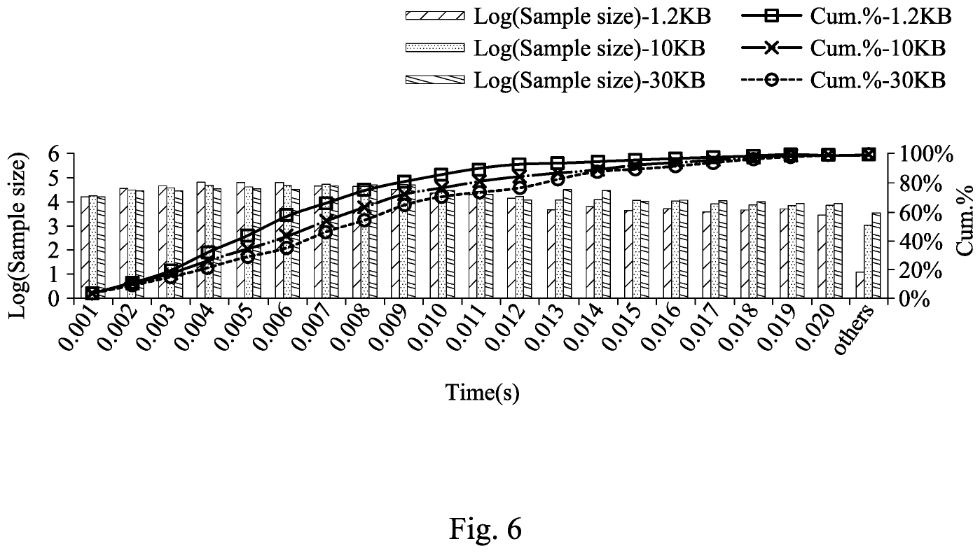

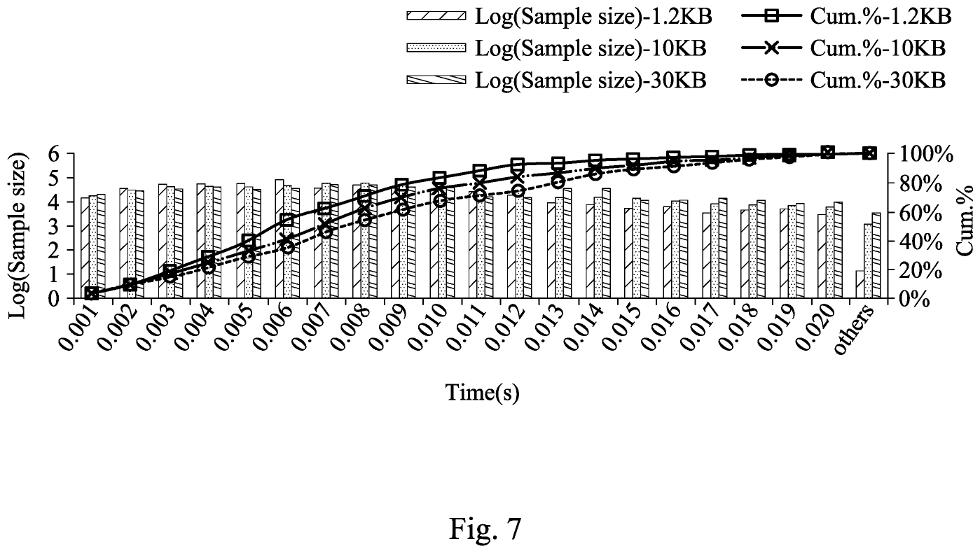

Reference is made to FIGS. 1, 2, 3, 4, 5, 6, and 7. FIG. 6 shows a schematic view of a writing delay of states of a production tool utilizing a publish subscribe mechanism 310 of the present disclosure when a writing frequency is 100 Hz. FIG. 7 shows a schematic view of a writing delay of states of a production tool utilizing a publish subscribe mechanism 310 of the present disclosure when a writing frequency is 10 Hz. In FIGS. 6 and 7, the publish subscribe mechanism 310 utilizes three different data sizes of 1.2 KB, 10 KB, and 30 KB with different writing frequencies. In practice, when the condition of the production tool is changed, the data size is about 1.2 KB. The writing frequency of FIG. 6 is 100 Hz, and the writing frequency of FIG. 7 is 10 Hz. The horizontal axis represents “Time(s)”. The left vertical axis represents “Log(sample size)”, and the right vertical axis represents “cumulative percentage of Log(sample size)”. “Cum.” represents cumulative values. After testing 580,000 samples, 99% of the states of the production tool have a delay time of 1-4 seconds in the architecture of the MES 110, and the time spent by the publish subscribe mechanism 310 of the present disclosure is less than 0.02 seconds. In the present disclosure, only 0.0043% of the total samples have a delay time greater than 0.1 seconds, and 0.25% of the messages have a transmission delay time greater than 10 seconds so the present disclosure has high efficiency in message transmission.

It is understood that the near-optimal scheduling method SO for considering processing-time variations and real-time data streaming of the present disclosure is performed by the aforementioned steps. A computer program of the present disclosure stored on a non-transitory tangible computer readable recording medium is used to perform the method described above. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like).

It is also noted that the present disclosure also can be described in the context of a manufacturing system. Although the present disclosure may be implemented in semiconductor fabrication, the present disclosure is not limited to implementation in semiconductor fabrication and may be applied to other manufacturing industries, in which the manufacturing system is configured to fabricate workpieces or products including, but not limited to, microprocessors, memory devices, digital signal processors, application specific integrated circuits (ASICs), or other similar devices. The present disclosure may also be applied to workpieces or manufactured products other than semiconductor devices, such as vehicle wheels, and screws. The manufacturing system includes one or more processing tools that may be used to form one or more products, or portions thereof, in or on the workpieces (such as wafers, and glass substrates). Persons of ordinary skill in the art should appreciate that the processing tools may be implemented in any number of entities of any type, including lithography tools, deposition tools, etching tools, polishing tools, annealing tools, machine tools, and the like. In the embodiments, the manufacturing system also includes one or more metrology tools, such as scatterometers, ellipsometers, scanning electron microscopes, and the like.

According to the aforementioned embodiments and examples, the advantages of the present disclosure are described as follows.
1. The near-optimal scheduling system for considering processing-time variations and real-time data streaming and a method thereof of the present disclosure provide an optimized production schedule based on the predicted operation processing time and the publish subscribe mechanism to overcome the problems of the uncertain processing time and lack of considering on-site conditions in the conventional scheduling technique.
2. The mixed integer programming combined with the ordinal-optimization (OO) embedded decomposition and coordination method can effectively improve the efficiency of optimizing scheduling for multiple products on multiple production tools, and enable the optimized schedule to be conformed with the behavior of actual production.
3. The use of the publish subscribe mechanism can effectively solve the delay of states of the production tools and on-site production conditions, thereby effectively improving the transmission efficiency of the production tools and production-related information.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A near-optimal scheduling system for considering processing-time variations and real-time data streaming, comprising:
a data parser module configured to parse a plurality of sets of historical work-in-process (WIP) data generated by a manufacturing execution system (MES) in past multiple production periods according to a statistical method, thereby obtaining a plurality of historical features of operation processing time in the multiple production periods;
a publish subscribe mechanism module signally connected to the data parser module and receiving the historical features of operation processing time, wherein the publish subscribe mechanism module transmits the historical features of operation processing time via a publish subscribe mechanism;
a processing time prediction module signally connected to the publish subscribe mechanism module and receiving the historical features of operation processing time, wherein the processing time prediction module analyzes the historical features of operation processing time according to an orthogonal greedy algorithm (OGA) and a recurrent neural network (RNN), thereby obtaining a predicted operation processing time in a next production period, and transmits the predicted operation processing time to the publish subscribe mechanism module; and
a scheduling optimization module signally connected to the publish subscribe mechanism module and receiving the predicted operation processing time, wherein the scheduling optimization module executes an ordinal-optimization algorithm on the predicted operation processing time to generate an optimized schedule report so that the optimized schedule report considers variation of the predicted operation processing time.

2. The near-optimal scheduling system for considering processing-time variations and real-time data streaming of claim 1, wherein the data parser module is activated by a first trigger signal for every first time period, the processing time prediction module is activated by a second trigger signal for every second time period, and the scheduling optimization module is activated by a third trigger signal, a length of the first time period is different from a length of the second time period, and the first trigger signal, the second trigger signal, and the third trigger signal are different from each other.

3. The near-optimal scheduling system for considering processing-time variations and real-time data streaming of claim 1, wherein the statistical method comprises at least one of an average value method, a standard deviation method, and a quartile method, the orthogonal greedy algorithm is a triple-phase orthogonal greedy algorithm (TPOGA), and the recurrent neural network is a long short-term memory (LSTM).

4. The near-optimal scheduling system for considering processing-time variations and real-time data streaming of claim 1, wherein the ordinal-optimization algorithm comprises:
performing an initializing step, wherein the initializing step comprises initializing the predicted operation processing time to a predetermined value and performing linear programming (LP) for a sorting problem of the predicted operation processing time to decompose the sorting problem into a plurality of linear programming subproblems, and the predetermined value comprises a non-integer.

5. The near-optimal scheduling system for considering processing-time variations and real-time data streaming of claim 4, wherein the ordinal-optimization algorithm further comprises:
performing a solving step, wherein the solving step comprises sequentially calling each of the linear programming subproblems, and solving each of the linear programming subproblems by a linear programming solver to obtain a non-integer variable.

6. The near-optimal scheduling system for considering processing-time variations and real-time data streaming of claim 5, wherein the ordinal-optimization algorithm further comprises:
performing a rounding step, wherein the rounding step comprises rounding the non-integer variable to generate a rounded integer variable; and
performing a checking step, wherein the checking step comprises checking feasibility of the rounded integer variable to generate a feasibility check result and then determining to perform one of a subproblem cost computing step and a processing step according to the feasibility check result.

7. The near-optimal scheduling system for considering processing-time variations and real-time data streaming of claim 6, wherein,
in response to determining that the feasibility check result of the checking step is feasible, the subproblem cost computing step is performed, and the subproblem cost computing step comprises computing cost of each of the linear programming subproblems to generate a subproblem cost value; and
in response to determining that the feasibility check result of the checking step is non-feasible, the processing step is performed, and the processing step comprises performing a ceiling operation and a flooring operation on the non-integer variable to generate a ceiling integer variable and a flooring integer variable.

8. The near-optimal scheduling system for considering processing-time variations and real-time data streaming of claim 7, wherein the ordinal-optimization algorithm further comprises:
performing a judging step, wherein the judging step is performed after the subproblem cost computing step and comprises judging whether the subproblem cost value obtained in a current time satisfies a surrogate optimality condition to generate a conditional judgment result, and the surrogate optimality condition comprises that the subproblem cost value obtained in the current time is smaller than the subproblem cost value obtained in a previous time;
wherein in response to determining that the conditional judgment result is yes, a multiplier updating step is performed, and then the solving step is repeatedly performed, and the multiplier updating step comprises updating a Lagrangian multiplier;
wherein in response to determining that the conditional judgment result is no, the processing step is performed.

9. The near-optimal scheduling system for considering processing-time variations and real-time data streaming of claim 7, wherein the ordinal-optimization algorithm further comprises:
performing a finding and computing step, wherein the finding and computing step is performed after the processing step and comprises finding a feasible solution by using the ceiling integer variable and the flooring integer variable and computing cost of one of the linear programming subproblems corresponding to the feasible solution to generate another subproblem cost value.

10. The near-optimal scheduling system for considering processing-time variations and real-time data streaming of claim 9, wherein the ordinal-optimization algorithm further comprises:
performing a confirming step, wherein the confirming step is performed after the finding and computing step and comprises confirming whether the another subproblem cost value obtained in a current time satisfies another surrogate optimality condition to generate a conditional confirmation result, and the another surrogate optimality condition comprises that the another subproblem cost value obtained in the current time is smaller than the subproblem cost value obtained in a previous time;
wherein in response to determining that the conditional confirmation result is yes, the ordinal-optimization algorithm is stopped;
wherein in response to determining that the conditional confirmation result is no, a subproblem solving step is performed, and then a multiplier updating step is performed, the subproblem solving step comprises solving each of the linear programming subproblems by using a branch and cut algorithm, and the multiplier updating step comprises updating a Lagrangian multiplier.

11. A near-optimal scheduling system for considering processing-time variations and real-time data streaming, comprising:
a memory configured to store a plurality of sets of historical work-in-process (WIP) data generated by a manufacturing execution system (MES) in past multiple production periods and a plurality of instructions; and
a processor signally connected to the memory, wherein the processor executes the instructions to:
perform a data parser operation, the data parser operation comprising parsing the sets of historical work-in-process data according to a statistical method, thereby obtaining a plurality of historical features of operation processing time in the multiple production periods;
perform a first publish subscribe mechanism operation, the first publish subscribe mechanism operation comprising transmitting the historical features of operation processing time via a publish subscribe mechanism;
perform a processing time prediction operation, the processing time prediction operation comprising analyzing the historical features of operation processing time according to an orthogonal greedy algorithm (OGA) and a recurrent neural network (RNN), thereby obtaining a predicted operation processing time in a next production period;
perform a second publish subscribe mechanism operation, the second publish subscribe mechanism operation comprising transmitting the predicted operation processing time via the publish subscribe mechanism; and
perform a scheduling optimization operation, the scheduling optimization operation comprising executing an ordinal-optimization algorithm on the predicted operation processing time to generate an optimized schedule report so that the optimized schedule report considers variation of the predicted operation processing time.

12. A near-optimal scheduling method for considering processing-time variations and real-time data streaming, comprising:
performing a data parsing step, wherein the data parsing step comprises configuring a data parser module to parse a plurality of sets of historical work-in-process (WIP) data generated by a manufacturing execution system (MES) in past multiple production periods according to a statistical method, thereby obtaining a plurality of historical features of operation processing time in the multiple production periods;
performing a first publish subscribe mechanism step, wherein the first publish subscribe mechanism step comprises configuring a publish subscribe mechanism module to transmit the historical features of operation processing time via a publish subscribe mechanism;
performing a processing time predicting step, wherein the processing time predicting step comprises configuring a processing time prediction module to analyze the historical features of operation processing time according to an orthogonal greedy algorithm (OGA) and a recurrent neural network (RNN), thereby obtaining a predicted operation processing time in a next production period;
performing a second publish subscribe mechanism step, wherein the second publish subscribe mechanism step comprises configuring the publish subscribe mechanism module to transmit the predicted operation processing time via the publish subscribe mechanism; and
performing a scheduling optimization step, wherein the scheduling optimization step comprises configuring a scheduling optimization module to execute an ordinal-optimization algorithm on the predicted operation processing time to generate an optimized schedule report so that the optimized schedule report considers variation of the predicted operation processing time.

13. The near-optimal scheduling method for considering processing-time variations and real-time data streaming of claim 12, wherein,
the data parser module is activated by a first trigger signal for every first time period, the processing time prediction module is activated by a second trigger signal for every second time period, and the scheduling optimization module is activated by a third trigger signal, a length of the first time period is different from a length of the second time period, and the first trigger signal, the second trigger signal, and the third trigger signal are different from each other; and
the statistical method comprises at least one of an average value method, a standard deviation method, and a quartile method, the orthogonal greedy algorithm is a triple-phase orthogonal greedy algorithm (TPOGA), and the recurrent neural network is a long short-term memory (LSTM).

14. The near-optimal scheduling method for considering processing-time variations and real-time data streaming of claim 12, wherein the ordinal-optimization algorithm comprises:
performing an initializing step, wherein the initializing step comprises initializing the predicted operation processing time to a predetermined value and performing linear programming (LP) for a sorting problem of the predicted operation processing time to decompose the sorting problem into a plurality of linear programming subproblems, and the predetermined value comprises a non-integer.

15. The near-optimal scheduling method for considering processing-time variations and real-time data streaming of claim 14, wherein the ordinal-optimization algorithm further comprises:
performing a solving step, wherein the solving step comprises sequentially calling each of the linear programming subproblems, and solving each of the linear programming subproblems by a linear programming solver to obtain a non-integer variable.

16. The near-optimal scheduling method for considering processing-time variations and real-time data streaming of claim 15, wherein the ordinal-optimization algorithm further comprises:
performing a rounding step, wherein the rounding step comprises rounding the non-integer variable to generate a rounded integer variable; and
performing a checking step, wherein the checking step comprises checking feasibility of the rounded integer variable to generate a feasibility check result and then determining to perform one of a subproblem cost computing step and a processing step according to the feasibility check result.

17. The near-optimal scheduling method for considering processing-time variations and real-time data streaming of claim 16, wherein,
in response to determining that the feasibility check result of the checking step is feasible, the subproblem cost computing step is performed, and the subproblem cost computing step comprises computing cost of each of the linear programming subproblems to generate a subproblem cost value; and
in response to determining that the feasibility check result of the checking step is non-feasible, the processing step is performed, and the processing step comprises performing a ceiling operation and a flooring operation on the non-integer variable to generate a ceiling integer variable and a flooring integer variable.

18. The near-optimal scheduling method for considering processing-time variations and real-time data streaming of claim 17, wherein the ordinal-optimization algorithm further comprises:
performing a judging step, wherein the judging step is performed after the subproblem cost computing step and comprises judging whether the subproblem cost value obtained in a current time satisfies a surrogate optimality condition to generate a conditional judgment result, and the surrogate optimality condition comprises that the subproblem cost value obtained in the current time is smaller than the subproblem cost value obtained in a previous time;
wherein in response to determining that the conditional judgment result is yes, a multiplier updating step is performed, and then the solving step is repeatedly performed, and the multiplier updating step comprises updating a Lagrangian multiplier;
wherein in response to determining that the conditional judgment result is no, the processing step is performed.

19. The near-optimal scheduling method for considering processing-time variations and real-time data streaming of claim 17, wherein the ordinal-optimization algorithm further comprises:
performing a finding and computing step, wherein the finding and computing step is performed after the processing step and comprises finding a feasible solution by using the ceiling integer variable and the flooring integer variable and computing cost of one of the linear programming subproblems corresponding to the feasible solution to generate another subproblem cost value.

20. The near-optimal scheduling method for considering processing-time variations and real-time data streaming of claim 19, wherein the ordinal-optimization algorithm further comprises:
performing a confirming step, wherein the confirming step is performed after the finding and computing step and comprises confirming whether the another subproblem cost value obtained in a current time satisfies another surrogate optimality condition to generate a conditional confirmation result, and the another surrogate optimality condition comprises that the another subproblem cost value obtained in the current time is smaller than the subproblem cost value obtained in a previous time;
wherein in response to determining that the conditional confirmation result is yes, the ordinal-optimization algorithm is stopped;
wherein in response to determining that the conditional confirmation result is no, a subproblem solving step is performed, and then a multiplier updating step is performed, the subproblem solving step comprises solving each of the linear programming subproblems by using a branch and cut algorithm, and the multiplier updating step comprises updating a Lagrangian multiplier.
